(19) United States
(12) Patent Application Publication
(10) Pub. No.: US 2006/0126050 A1
(43) Pub. Date: Jun. 15, 2006

(54) Substrate holding device, substrate holding method and substrate heating device

(75) Inventor: Shinya Momose, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/298,830

(22) Filed: Dec. 12, 2005

(30) Foreign Application Priority Data
Dec. 15, 2004 (JP) 2004-363472

(51) Int. Cl. G03B 27/58

(52) U.S. Cl. 355/72; 355/75

(57) ABSTRACT

A substrate holding device comprises a holding table for holding a substrate, heating means for heating the holding table, and attraction means for causing the substrate to be attracted onto the holding table. When the substrate which has warped is placed on the holding table heated by the heating means, the attraction means causes a plurality of regions of the substrate to be attracted and held with different timings in accordance with the amount of a decrease in warpage of the substrate due to heat of the holding table.

### BACKGROUND OF THE INVENTION

1. Field of the Invention

This invention relates to a substrate holding device and a substrate holding method, which are preferred for attracting and holding a substrate, such as a silicon wafer, especially, a warped substrate, on a holding table. The invention also relates to a substrate heating device.

2. Description of the Related Art

When a predetermined solution (solvent) of a resist material or an insulation material is to be coated on a substrate, such as a silicon wafer, a film forming device using the spin coating method, for example, is generally used. An alternative is, for example, a slit-coating type coating device which allows a solution to flow out from the front end of a nozzle by capillarity and coats the solution on the face of a substrate (see, for example, Japanese Patent Application Laid-Open No. 1994-343908).

With such devices, it is difficult to coat the solution uniformly, unless the substrate to be coated with the solution is flat. In coating the solution on a warped substrate, therefore, it is, necessary to remedy the warpage of the substrate for flattening. If a film has been formed on the substrate, on the other hand, warpage is caused to the substrate owing to, for example, a difference in thermal expansion coefficient between the substrate and the film.

A proposed method for flattening the substrate is, for example, to suck a surface of the substrate opposite to its surface to be coated with the solution, thereby attracting the substrate under vacuum (see, for example, Japanese Patent Application Laid-Open No. 2001-185607). Another proposal is a method which holds down an edge portion of the substrate by a substrate hold-down member to flatten the substrate (see, for example, Japanese Patent Application Laid-Open No. 2001-127041). The use of these methods enables the substrate to be flattened. However, if the amount of warpage of the substrate is relatively large, a problem such as the cracking of the substrate may occur. Furthermore, there is a method which lowers the film forming temperature during the formation of the film on the substrate, or changes the pressure of Ar, for example, thereby remedying the warpage of the substrate (see, for example, Japanese Patent Application Laid-Open No. 1998-125905). However, these methods still have difficulty in completely remedying the warpage of the substrate.

Another problem may also exist. If a resist material is coated on the substrate by any of the above-mentioned devices, for example, heat-treatment such as pre-bake or post-bake of the resist is performed in a subsequent step. When such heat-treatment is carried out, warpage of the substrate, if any, results in nonuniformity of the film quality of the resulting resist film.

### SUMMARY OF THE INVENTION

The present invention has been accomplished in the light of the above-described circumstances. It is an object of the present invention to provide a substrate holding device and a substrate holding method, which can satisfactorily attract and hold a warped substrate, in a nearly flat state, onto a holding table, and a substrate heating device which can perform satisfactory heat-treatment of a resist or the like coated on the substrate.

A first aspect of the present invention for attaining the above object is a substrate holding device comprising: a holding table for holding a substrate; heating means for heating the holding table; and attraction means for causing the substrate to be attracted onto the holding table, and wherein when the substrate which has warped is placed on the holding table heated by the heating means, the attraction means causes a plurality of regions of the substrate to be attracted and held with different timings in accordance with an amount of a decrease in warpage of the substrate due to heat of the holding table.

In the first aspect, the warpage of the substrate is remedied without cracking or the like caused to the substrate, whereby the substrate can be flatted efficiently and attracted to and held by the holding table.

A second aspect of the present invention is the substrate holding device according to the first aspect, characterized in that the attraction means causes a plurality of concentric regions of the substrate to be attracted with different timings.

In the second aspect, the warpage of the substrate can be remedied satisfactorily, so that the substrate can be flatted more efficiently and attracted to and held by the holding table.

A third aspect of the present invention is the substrate holding device according to the first or second aspect, characterized in that the holding table has a plurality of suction holes each having one end opening at a surface of the holding table, and the attraction means is suction means for sucking the substrate via the suction holes.

In the third aspect, the substrate is attracted to the holding table by vacuum suction or the like. Thus, different regions of the substrate can be attracted to and held by the holding table relatively easily with different timings.

A fourth aspect of the present invention is the substrate holding device according to any one of the first to third aspects, further comprising measuring means for measuring at least an amount of warpage of a peripheral edge portion of the substrate.

In the fourth aspect, the warpage of the substrate can be remedied further satisfactorily, and the occurrence of cracks or the like in the substrate can be prevented reliably.

A fifth aspect of the present invention is a substrate heating device comprising the substrate holding device of any one of the first to fourth aspects.

In the fifth aspect, a film of a resist or the like, which has been formed on the substrate, is heated uniformly, whereby a satisfactory film can be formed.

A sixth aspect of the present invention is a substrate holding method for causing a substrate to be attracted onto and held on a holding table, comprising: laminating a remediation film for remedying warpage of the substrate to one surface of the substrate; placing the substrate on the holding table, with the remediation film being pointed downward; heating the substrate in such a state; and causing a plurality of regions of the substrate to be attracted onto the holding table with different timings in accordance with an amount of a decrease in warpage of the substrate by the heating.

In the sixth aspect, the warpage of the substrate is remedied without cracking or the like caused to the substrate, whereby the substrate can be flatted efficiently and attracted to and held by the holding table.

A seventh aspect of the present invention is the substrate holding method according to the sixth aspect, characterized in that the substrate is a silicon wafer or a glass substrate.

In the seventh aspect, even when a substrate comprising a relatively crackable material is held on the holding table, warpage of the substrate can be remedied, with cracking or the like of the substrate being reliably prevented.

An eighth aspect of the present invention is the substrate holding method according to the sixth or seventh aspect, characterized in that the warpage remediation film is a heat-peelable film.

In the eighth aspect, warpage of the substrate can be remedied effectively. Moreover, since the warpage remediation film can be removed easily from the substrate, the efficiency of manufacturing is not decreased.

### BRIEF DESCRIPTION OF THE DRAWINGS

For a more complete understanding of the present invention and the advantages thereof, reference is now made to the following descriptions in conjunction with the accompanying drawings.

FIG. 1 is a perspective view showing an outlined configuration of a coating device according to an embodiment of the present invention.

FIGS. 2A and 2B are a plan view and a sectional view, respectively, of a substrate holding device according to the embodiment of the present invention.

FIGS. 3A and 3B are views illustrating a substrate holding method according to the embodiment of the present invention.

FIGS. 4A and 4B are views illustrating the substrate holding method according to the embodiment of the present invention.

FIG. 5 is a graph showing changes in the amount of warpage of a substrate with the passage of time.

FIG. 6 is a view illustrating a method for measuring the amount of warpage of the substrate.

FIGS. 7A to 7C are views showing actions of the coating device according to the embodiment of the present invention.

### DESCRIPTION OF THE PREFERRED EMBODIMENTS

The present invention will now be described in detail based on its embodiments with reference to the accompanying drawings.

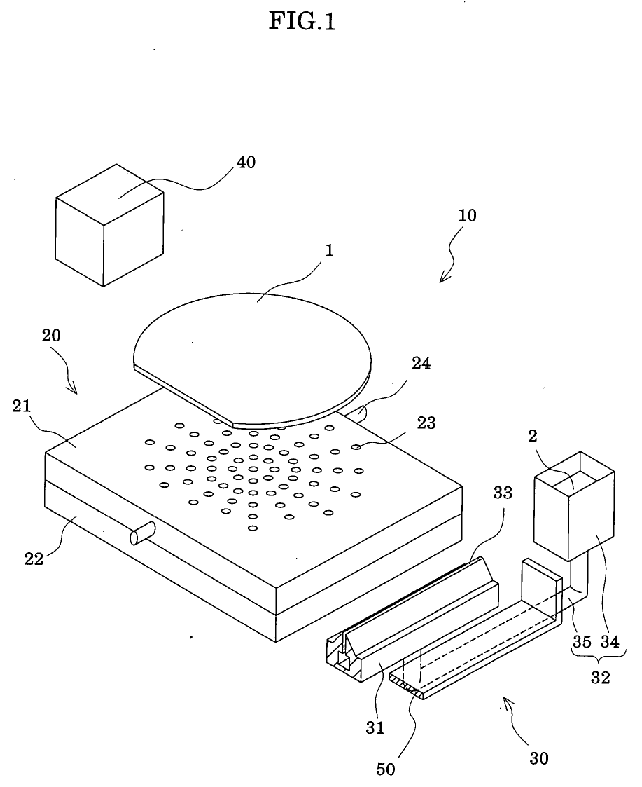

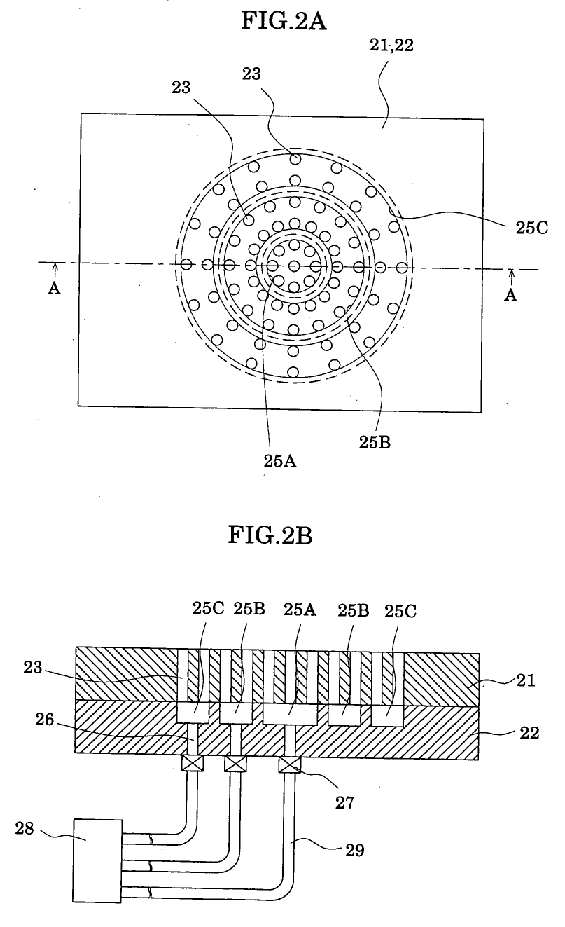

FIG. 1 is a perspective view showing the outlined configuration of a slit-coating type coating device according to an embodiment of the present invention. FIGS. 2A and 2B are a plan view and a sectional view, respectively, of a substrate holding device. In the present embodiment, a resist film, which is used for patterning of a metal film formed on the face of a substrate as a silicon wafer and comprising, for example, gold (Au), is formed by the slit-coating type coating device. The substrate has the metal film formed on its face, and stress relationship occurs between the substrate and the metal film. For this and other reasons, warpage is caused to render the back of the substrate convex. The present invention is designed to attract the substrate to a holding table while remedying the warpage of the substrate, thereby flattening the substrate efficiently and attracting and holding the substrate satisfactorily onto the holding table.

As shown in FIG. 1, a slit-coating type coating device 10 according to the present embodiment is composed of a substrate holding device 20 for holding a substrate 1, and a coating device 30 for coating the face of the substrate 1 with a resist.

The substrate holding device 20 comprises a holding table 21, which attracts and holds the substrate 1, and a passage member 22 provided on the back of the holding table 21. As shown in FIGS. 2A and 2B, the holding table 21 has a plurality of suction holes 23 in a region where the substrate 1 is placed, the suction holes each having an end which opens at the surface of the holding table 21. In the present embodiment, for example, these suction holes 23 are provided in such a manner as to penetrate the holding table 21 in its thickness direction. In the present embodiment, moreover, the respective suction holes 23 are arranged in a nearly circular form in agreement with the planar shape of the substrate 1 which is a silicon wafer. Further, the holding table 21 is formed such that it can be heated, as a whole, to a predetermined temperature by a predetermined heating means, although this is not shown. In the present embodiment, for example, the holding table 21 is provided with a heating means of the electronic heating type, and can be cooled as well as heated. The holding table 21, moreover, is supported rotatably about a rotating shaft 24 and, further, is provided so as to be movable along the planar direction of the substrate 1 by a table drive means such as a drive motor (not shown).

The passage member 22 has a surface where a plurality of suction paths, 25A to 25C, are formed independently. In the present embodiment, for example, the first suction path 25A of a nearly circular form is provided in a region opposed to the center of the nearly circular shape in which the suction holes 23 are arranged. Outwardly of the first suction path 25A, there are provided the second suction path 25B and the third suction path 25C which extend annularly and uninterruptedly around the first suction path 25A. The passage member 22 is fixed to the back of the holding table 21 on the side of the suction paths 25A to 25C, and the suction holes 23 of the holding table 21 communicate with any one of the suction paths 25A to 25C.

In the passage member 22, communicating holes 26, which communicate with the outside at the other surface of the passage member 22, are provided in communication with the suction paths 25A to 25C. To the communicating holes 26, suction pipes 29 are detachably connected via opening and closing valves 27. The suction pipes 29 have one end connected to a suction means 28, such as a vacuum pump.

In the present embodiment, the substrate holding device 20 includes a measuring means 40. The measuring means 40 is provided upwardly, in a vertical direction, of the holding table 21, and measures the amount of warpage in different regions of the substrate 1 placed on the holding table 21. In the present embodiment, for example, a laser displacement meter, which irradiates an object with laser light to measure a distance to the object, is used as the measuring means 40.

In the substrate holding device 20 of the present embodiment, warpage of the substrate 1 is remedied by heating the substrate 1 by means of the holding table 21, and a plurality of regions of the substrate 1 are attracted and held by the holding table 1 via the suction holes 23 with different timings in accordance with the amount of decrease in the warpage of the substrate 1, although the details of this procedure will be described later. Because of this procedure, the warpage of the substrate 1 can be remedied satisfactorily and efficiently, and the substrate 1 can be attracted to and held by the holding table 21 satisfactorily, while being flattened without cracks.

The coating device 30 comprises a coating head 31 and a storage means 32. The coating head 31 has a slit-shaped nozzle orifice 33 which is open upwardly in a vertical direction, and through which a resist 2 supplied from the storage means 32 flows out. The coating head 31 is held by a device body (not shown) so as to be movable in a vertical direction. Thus, the spacing between the front end of the coating head 31 and the face of the substrate 1 can be adjusted, as appropriate, in consideration of, for example, the kinematic viscosity of the resist 2, the wettability of the substrate 1 with the resist 2, and the thickness of the resist 2 coated on the substrate 1.

The storage means 32 is composed of a storage tank 34 for holding the resist 2, and a supply pipe 35 having one end connected to the coating head 31 and the other end connected to the storage tank 34. The storage means 32 supplies the resist 2, stored inside the storage tank 34, to the coating head 31 via the supply pipe 35.

In the present embodiment, a shielding plate 50 is provided in the direction of movement of the holding table 21 and behind the coating head 31 so as to cover a part of the face of the substrate 1 without touching the face of the substrate 1. The provision of this shielding plate 50 can prevent changes in the coating conditions due to changes in the viscosity of the resist 2 upon heating of the resist 2 being coated, for example, when the resist 2 coated on the substrate 1 is dried while the resist 2 is being coated.

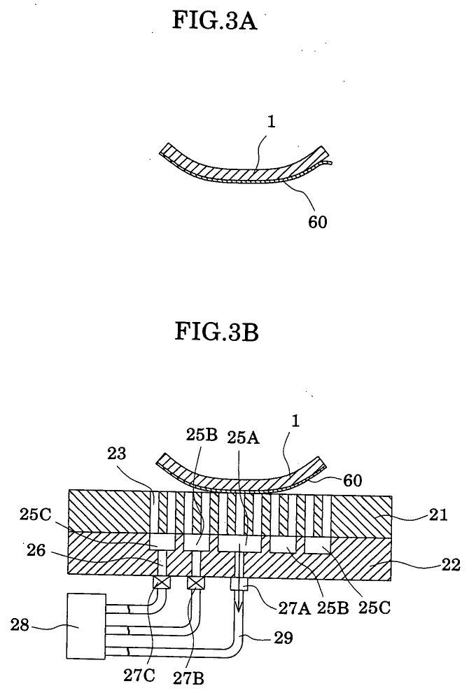

The method of forming a resist film with the use of the above-described slit-coating type coating device 10 will be described. First, an explanation will be offered for the method of attracting and holding the substrate 1 onto the holding table 21 of the substrate holding device 20. FIGS. 3A and 3B are schematic views illustrating the substrate holding method according to the present embodiment.

In the present embodiment, as shown in FIG. 3A, the first step is to laminate a warpage remediation film 60, which comprises a predetermined material, to the back of the substrate 1 undergoing warpage, namely, the surface of the substrate 1 opposite to the surface to be coated with a resist. The warpage remediation film 60 is a film which, upon heating, shrinks or expands to generate a change in stress, thereby decreasing the warpage of the substrate 1. The material for the warpage remediation film 60 is not limited, and may be determined, as appropriate, in consideration of the direction of warpage of the substrate 1, the amount of warpage, and so on. In the present embodiment, for example, the substrate 1 warps such that its back is convex, and the warpage remediation film 60 is laminated to the convex side of the substrate 1. Thus, a film which shrinks upon heating to generate stress in the direction of compression, concretely, a so-called heat-peelable film which comprises polyester or the like and can spontaneously peel off upon heating, is used as the warpage remediation film 60.

At a stage where the warpage remediation film 60 has been laminated to the substrate 1, the amount of warpage of the substrate 1 decreases markedly. Concretely, the amount of warpage of the substrate 1 decreases nearly to a half, as compared with that present before lamination of the warpage remediation film 60.

Then, as shown in FIG. 3B, the substrate 1 having the warpage remediation film 60 laminated thereto is placed at a predetermined position on the holding table 21 held vertically upwardly, namely in the present embodiment, in a region where the plurality of suction holes 23 arranged in the nearly circular shape are formed. The substrate 1 placed in this state is sucked via the suction holes 23 communicating with the suction path 25A until it is attracted to and held by the holding table 21. That is, the substrate 1 is sucked only through the suction holes 23 corresponding to the central region of the substrate 1 actually in contact with the surface of the holding table 21, whereby only a central portion of the substrate 1 is attracted onto the holding table 21. Concretely, the suction means 28 is actuated, with the opening and closing valves 27 provided at the opening portions of the communicating holes 26 being closed, to open only the opening and closing valve 27A corresponding to the suction path 25A. As a result, the substrate 1 is sucked via the communicating hole 26, the suction path 25A and the suction holes 23, so that only the central region of the substrate 1 is attracted onto the holding table 21. At this time, the holding table 21 is heated by the heating means (not shown), and kept at a predetermined temperature, i.e., about 90° C. in the present embodiment.

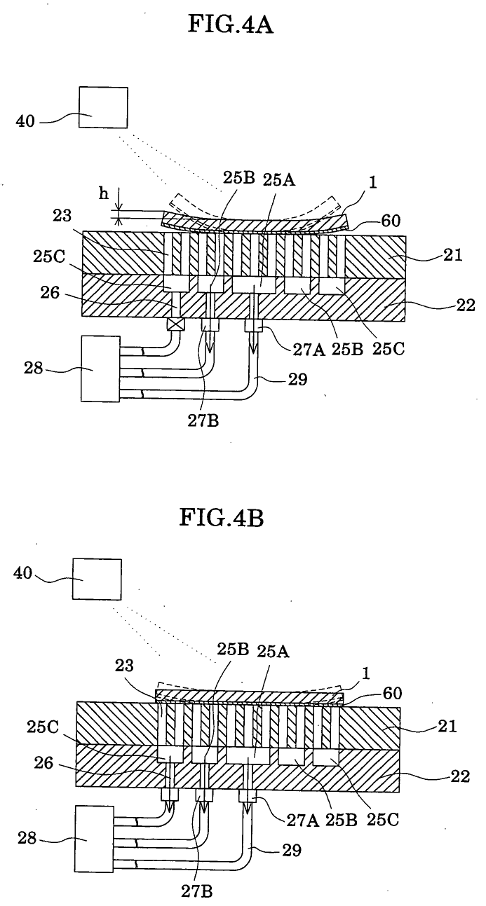

The substrate 1 is held for a predetermined period of time, for example, several seconds to several tens of seconds, with only its central portion being attracted to the holding table 21. By this operation, the substrate 1 and the warpage remediation film 60 are heated by the holding table 21, whereupon the warpage of the substrate 1 is remedied as described above, with the result that the amount of warpage of the substrate 1 gradually decreases. In the present embodiment, as shown in FIG. 4A, the amount of warpage of the substrate 1 on this occasion is measured by the measuring means 40. Based on the results of the measurement, the substrate 1 is sucked, with a predetermined timing, through the suction holes 23 communicating with the suction path 25B, and thereby attracted to the holding table 21. That is, the timing with which the substrate 1 substantially contacts the region corresponding to the suction holes 23 communicating with the suction path 25B is determined by the amount of warpage, h, of the substrate measured by the measuring means 40. With this timing, the opening and closing valve 27B corresponding to the suction path 25B is opened to suck the substrate 1 via the suction holes 23 communicating with the suction path 25B.

Then, the substrate 1 and the warpage remediation film 60 are further heated, with the amount of warpage of the substrate 1 being measured by the measuring means 40. Then, the opening and closing valve 27C is opened with a timing with which the substrate 1 substantially contacts the region corresponding to the suction holes 23 communicating with the suction path 25C, to suck the substrate 1 via the suction holes 23 communicating with the suction path 25C. As a result, as shown in FIG. 4B, the substrate is sucked via all of the suction holes 23, so that the substrate is attracted to and held by the holding table 21, with the entire surface of the substrate being flattened.

According to the present invention, as described above, the warpage remediation film 60 is laminated to the substrate 1 to remedy the warpage of the substrate 1 to some degree, and the substrate 1 and the warpage remediation film 60 are heated to decrease the amount of warpage of the substrate 1. Moreover, the substrate 1 is attracted to the holding table 21 progressively in accordance with changes in the amount of warpage of the substrate 1. Thus, the warpage of the substrate 1 can be remedied satisfactorily and reliably without cracking or the like of the substrate 1, so that the substrate 1 can be flattened efficiently and attracted to and held by the holding table 21. The present invention is particularly effective, for example, in attracting and holding the substrate which is apt to crack, such as a silicon wafer or a glass substrate.

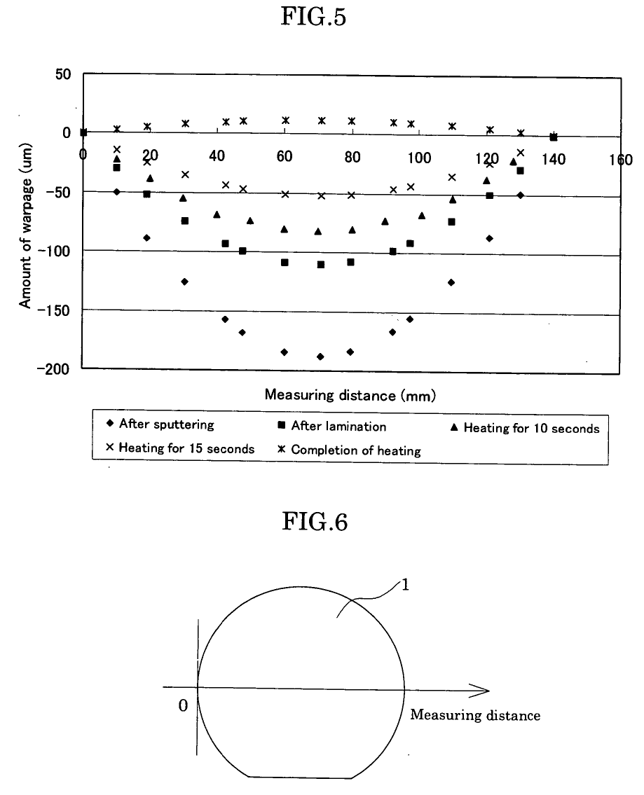

FIG. 5 shows the results of measurement of changes in the amount of warpage of the substrate (silicon wafer) when a heat-peelable film comprising a polyester film was laminated, as the warpage remediation film, to this substrate having a metal film formed thereon, and the substrate having the warpage remediation film laminated thereto was heated. A graph in FIG. 5 shows the results of measurement of the amount of warpage at a plurality of locations on a straight line passing a central part of the substrate 1 which was a silicon wafer, as FIG. 6 shows an example of measurement.

As shown in FIG. 5, immediately after the metal film was formed on the face of the substrate by the sputtering method, the amount of warpage of the substrate was of the order of 200 μm at the largest. However, the amount of warpage decreased nearly to a half by laminating the warpage remediation film to the back of the substrate. Further, when the substrate having the warpage remediation film laminated thereto was heated to a predetermined temperature, i.e., about 90° C. in this example, the amount of warpage of the substrate gradually decreased and, finally, the amount of warpage changed until the direction of warpage became opposite to the direction of warpage immediately after formation of the metal film.

As is clear from these results, the heating of the substrate having the warpage remediation film laminated thereto can reliably remedy the warpage of the substrate and decrease the amount of warpage. According to the present invention, it becomes possible to decrease the amount of warpage of the substrate in the above manner, and attract and hold a plurality of regions of the substrate with different timings in accordance with the amount of decrease in the warpage of the substrate, thereby attracting and holding the substrate onto the holding table while flattening the substrate efficiently.

After the substrate 1 is attracted to and held by the holding table 21 in the above-mentioned manner, the resist 2 is coated on the face of the substrate 1. The substrate 1 is heated by the heat of the holding table 21, when the substrate 1 is attracted to and held by the holding table 21. Thus, the substrate 1 is desirably cooled before being coated with the resist. The method of cooling is not limited, but it is recommendable to use an electronic heating type means, which is capable of heating and cooling, as a heating means for heating the holding table 21, as in the present embodiment, and cool the substrate 1 via the holding table 21.

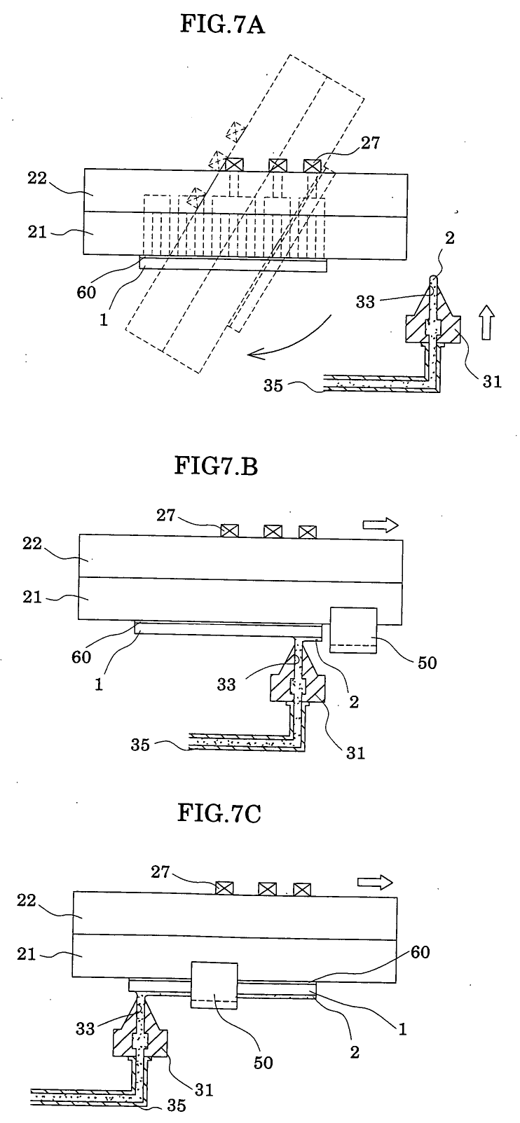

First, as shown in FIG. 7A, the holding table 21 and the passage member 22 are rotated 180°, with the opening and closing valves 27 being closed, to point the face of the substrate 1 downward in the vertical direction. The coating head 31 is raised to adjust the spacing between the face of the substrate 1 and the front end surface of the nozzle orifice 33 of the coating head 31 to be a predetermined spacing. That is, the coating head 31 is raised so that a front end portion of the resist 2 protruding from the nozzle orifice 33 comes to a position slightly higher than the position of the face of the substrate 1. In the present embodiment, the spacing between the coating head 31 and the substrate 1 is adjusted by moving the coating head 31. However, it goes without saying that the holding table 21 may be moved, with the coating head 31 remaining stationary.

Then, as shown in FIG. 7B, the holding table 21 is moved rectilinearly in the planar direction of the substrate 1, namely, in the horizontal direction, by the table drive means (not shown). By so doing, the resist 2 protruding from the nozzle orifice 33 of the coating head 31 contacts the face of the substrate (silicon wafer) 1, and begins to be coated thereon.

After coating of the resist 2 onto the face of the substrate 1 is thus started, the holding table 21 is further moved, as shown in FIG. 7C. During this motion, the resist 2 continuously flows out of the nozzle orifice 33, and is coated on the entire face of the substrate 1. In the present invention, as stated earlier, the substrate 1 is attracted to and held by the holding table 21 so as to be nearly flat. Thus, when the resist 2 is coated, the clearance between the face of the substrate 1 and the nozzle orifice 33 of the coating head 31 is kept constant, so that the resist 2 can be coated in a uniform thickness on the face of the substrate 1.

After the resist 2 is thus coated on the entire face of the substrate 1, the substrate 1 is heated to pre-bake the resist 2 coated. In the present embodiment, for example, the holding table 21 is heated again by the heating means (not shown) to pre-bake the coated resist 2. At this time, the substrate is held in a flattened state. Thus, optimal heating conditions are selected, and the resist 2 can be pre-baked always satisfactorily.

The slit-coating type coating device of the present embodiment is intended for operations up to pre-baking of the resist 2. After the resist 2 on the substrate 1 is pre-baked, the substrate 1 is detached from the holding table 21, and moved to an exposure/developing device for performing the exposure and development of the resist 2. Since the resist 2 is pre-baked in a satisfactory condition as described above, the effect is obtained that the uniformity of the resist 2 in treatments such as exposure and development can also be improved.

In the present embodiment, moreover, the substrate holding device 20 concurrently serves as a substrate heating device for heating the substrate 1 to pre-bake the resist 2. Of course, a substrate heating device for performing such pre-baking may be provided separately from the substrate holding device 20. When the substrate heating device is provided separately, the resist 2 can be pre-baked in good condition as mentioned above, if the substrate holding device 20 according to the present invention is adopted for the substrate heating device. Needless to say, if the substrate heating device is provided separately, the resist may be pre-baked by other method using radiant heat or the like. Furthermore, the substrate holding device 20 of the present invention may be used not only for the above-mentioned substrate heating device, but also for devices for performing exposure and development of the resist. By this measure, the uniformity of the resist can be improved further.

Although the embodiment of the present invention has been described above, it goes without saying that the present invention is not limited to this embodiment.

In the present embodiment, for example, the three regions are sucked with different timings, whereby the substrate is attracted onto and held by the holding table. However, more regions than these regions may be sucked with different timings and, of course, suction may be effected with a different timing for each suction hole. The structure for sucking the substrate via the suction holes is not limited.

In the present embodiment, moreover, the amount of warpage of the substrate is measured by the measuring means, when the substrate is attracted onto and held on the holding table. However, this is not limitative. For example, the amount of changes in the warpage of the substrate by heating may be measured beforehand, and the timings of suction of the respective regions may be set based on the data from these measurements.

Furthermore, in the present embodiment, the substrate is attracted onto and held on the holding table by vacuum attraction. However, it is permissible, for example, to attract and hold the substrate onto the holding table by electrostatic attraction.

Besides, in the present embodiment, the substrate warped to have an convex back is illustrated as an example. However, the substrate warped to have a convex face may be used. In this case, however, various conditions, such as the material, heating temperature, etc. for the warpage remediation film, should be selected as appropriate. Additionally, in the present embodiment, the present invention is illustrated, with the slit-coating type coating device being taken as an example. Needless to say, however, the present invention can be used for all devices requiring flattening of the substrate, such as a laminating device.

It should be understood that such changes, substitutions and alterations can be made therein without departing from the spirit and scope of the invention as defined by the appended claims.

What is claimed is:

1. A substrate holding device comprising:
a holding table for holding a substrate;
heating means for heating the holding table; and
attraction means for causing the substrate to be attracted onto the holding table, and
wherein when the substrate which has warped is placed on the holding table heated by the heating means, the attraction means causes a plurality of regions of the substrate to be attracted and held with different timings in accordance with an amount of a decrease in warpage of the substrate due to heat of the holding table.

2. The substrate holding device according to claim 1, wherein the attraction means causes a plurality of concentric regions of the substrate to be attracted with different timings.

3. The substrate holding device according to claim 1, wherein the holding table has a plurality of suction holes each having one end opening at a surface of the holding table, and the attraction means is suction means for sucking the substrate via the suction holes.

4. The substrate holding device according to claim 1, further comprising measuring means for measuring at least an amount of warpage of a peripheral edge portion of the substrate.

5. A substrate heating device comprising the substrate holding device of claim 1.

6. A substrate holding method for causing a substrate to be attracted onto and held on a holding table, comprising:
laminating a remediation film for remedying warpage of the substrate to one surface of the substrate;
placing the substrate on the holding table, with the remediation film being pointed downward;
heating the substrate in such a state; and
causing a plurality of regions of the substrate to be attracted onto the holding table with different timings in accordance with an amount of a decrease in warpage of the substrate by the heating.

7. The substrate holding method according to claim 6, wherein the substrate is a silicon wafer or a glass substrate.

8. The substrate holding method according to claim 6, wherein the warpage remediation film is a heat-peelable film.
